(19) United States
(12) Patent Application Publication
(10) Pub. No.: US 2009/0151463 A1
(43) Pub. Date: Jun. 18, 2009

(54) Non-contact pressure switch assembly

(76) Inventors: Mario A. Recio, Chihuahua (MX); Juan C. Lozano, Chihuahua (MX)

Correspondence Address: DELPHI TECHNOLOGIES, INC., M/C 480-410-202, PO BOX 5052, TROY, MI, 48007, US

(21) Appl. No.: 12/001,680

(22) Filed: Dec. 12, 2007

(51) Int. Cl. G01L 7/08; H01H 35/34; H01H 36/00; G01L 9/14

(52) U.S. Cl. 73/715; 73/700

(57) ABSTRACT

A non-contact pressure switch assembly for sensing pressure in, e.g., a vehicle. A piston with integrated magnet in a sensor body is moved under fluid pressure to change a magnetic field in which a Hall sensor is disposed inside the sensor body. The field changes polarity at the Hall sensor at a predetermined piston position.

### I. FIELD OF THE INVENTION

The present invention relates generally to pressure switches, and more particularly to non-contact pressure switches for vehicles.

### II. BACKGROUND OF THE INVENTION

Pressure switch manifolds are used in automotive transmission applications for direct sensing of fluid pressure. Applications include hydraulic feedback gear selection, shift timing/feel control, torque converter clutch control, solenoid feedback control, solenoid fault detection, and improved idle control.

As understood herein, contacting technology, in which case hydraulic pressure deflects or moves a diaphragm or spring loaded piston to create a short circuit condition that closes the contacting switch at a predefined hydraulic pressure valve, can be used but these structures are susceptible to contamination, corrosion, and wear. Furthermore, conductive particle contamination can generate the close (short switch) condition without pressure actuation, and corrosion and wear can prevent the close with pressure actuation.

As further understood herein, non-contact switches such as those that operate using the Hall effect tend to require a moving part to travel a distance that can be too large to be accommodated in certain applications, such as in vehicle transmissions. With these critical recognitions in mind, the invention herein is provided.

### SUMMARY OF THE INVENTION

A pressure switch assembly includes a sensor body juxtaposable with a fluid chamber and a piston disposed in the sensor body for reciprocal movement therein. A deflectable diaphragm is interposed between the piston and fluid chamber, with a spring urging the piston against the diaphragm. A magnet is coupled to the piston, and a Hall effect sensor defining a field threshold line outputs a signal that is affected by the position of the magnet in the sensor body. An axial midpoint of the magnet is on a first side of the field threshold line when the piston is urged by the spring to a depressurized position. On the other hand, the axial midpoint of the magnet is on a second side of the field threshold line when pressure in the chamber deflects the diaphragm to move the piston to a pressurized position.

The field threshold line may be along the axial midpoint of the Hall effect sensor. In some embodiments a portion of the magnet is above the field threshold line in the depressurized position and another portion of the magnet is below the field threshold line in the pressurized position. As pressure in the chamber moves the piston and, hence, the axial midpoint of the magnet across the field threshold line, the magnetic field at the Hall effect sensor prominently changes direction, resulting in a pronounced change in an output of the Hall effect sensor.

In another aspect, a method for sensing pressure includes moving a piston under fluid pressure to change a magnetic field in which a Hall sensor is disposed. The field changes polarity at a field threshold line of the Hall sensor at a predetermined piston position. A magnet generates the magnetic field and is coupled to the piston such that portions of the magnet remain on both sides of the field threshold line throughout an entire range of travel of the piston.

In still another aspect, a non-contact pressure switch assembly for sensing pressure in a vehicle includes a sensor body, a Hall sensor associated with the sensor body, and a piston with integrated magnet reciprocatingly disposed in the sensor body. The piston with magnet is moved under fluid pressure to change a magnetic field in which the Hall sensor is disposed. The field changes polarity at the Hall sensor at a predetermined piston position, and the magnet at all times straddles the Hall sensor in the dimension define by piston movement.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic block diagram of one intended environment of the present sensor, with double connecting lines indicating a fluid or mechanical connection and single connecting lines indicating a wired or wireless communication link;

FIG. 2 is a side elevational cut-away view of a non-limiting switch in accordance with present principles in the depressurized configuration; and

FIG. 3 is a side elevational cut-away view of a non-limiting switch in accordance with present principles in the pressurized configuration.

### DETAILED DESCRIPTION OF THE PREFERRED EMBODIMENT

The present invention overcomes the drawbacks associated with contacting switches by using a non-contacting magnetic switch. As contemplated herein, the present switch may be used but is not limited to an automotive transmission.

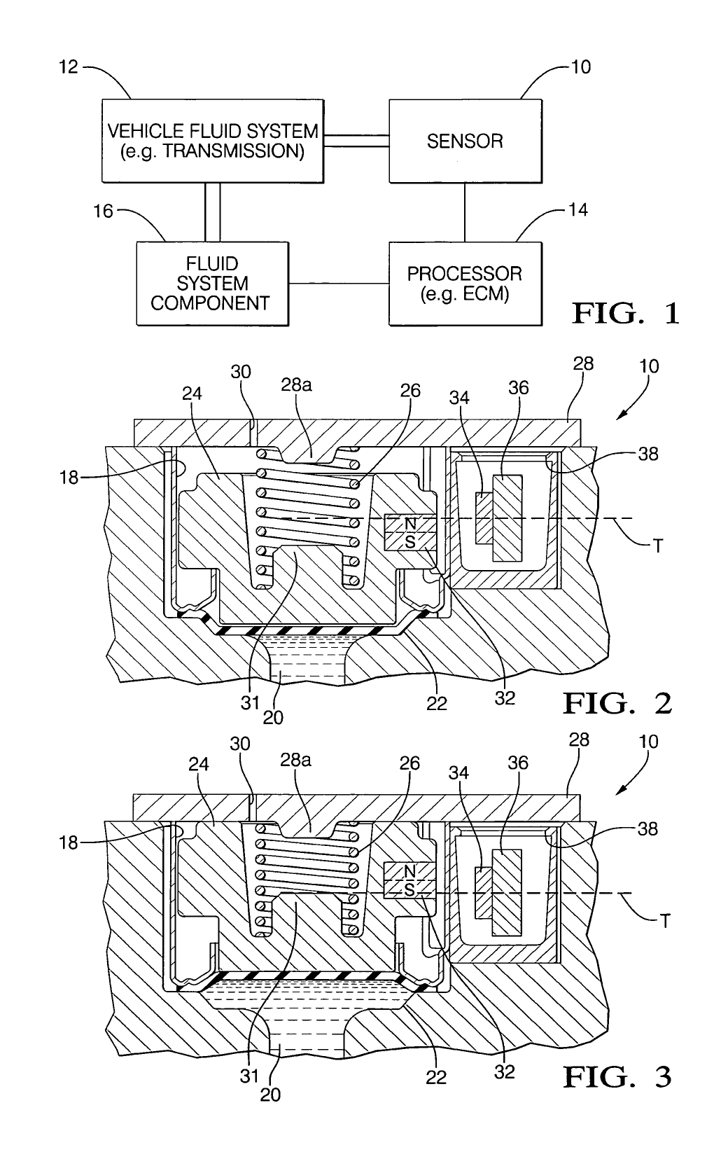

FIG. 1 illustrates a pressure sensor assembly 10 that is in fluid communication with a fluid system 12, such as a vehicle transmission system, to generate a signal representative of pressure in the fluid system 12. The signal may be sent (via appropriate processing circuitry and wired or wireless communication links) to a processor 14 such as a vehicle engine control module (ECM), with the processor 14 in response sending commands to a fluid system component 16 such as a valve or the like that is part of the fluid system 12.

FIG. 2 shows that the sensor 10 includes a hollow metal or hard plastic sensor body 18 juxtaposable with a fluid chamber 20, the pressure in which is imposed by the fluid system 12. A deflectable diaphragm 22 is engaged with the body 18 and is interposed between the chamber 20 and interior of the body 18 as shown. In non-limiting embodiments the diaphragm 22 may be made from woven backed Vamac.

A piston 24 is disposed in the body 20 against the diaphragm 22 for reciprocating movement along an axis between a depressurized position, shown in FIG. 2, and a pressurized position, shown in FIG. 3. When the piston 24 is in the pressurized position the sensor 10 assumes a pressurized configuration, and when the piston 24 is in the depressurized position the sensor 10 assumes a depressurized configuration. In non-limiting embodiments the piston 24 may be made of nylon.

As shown, a spring 26 is trapped in compression between the piston 24 and a cover 28 that is rigidly coupled to the body 18, such that the spring 26 urges the piston 24 toward the depressurized position of FIG. 2. The cover 28 may be formed with an exhaust port 30, and when pressure in the chamber 20 reaches a threshold, spring pressure against the piston 24 is overcome and the diaphragm 22 consequently is deflected to the configuration shown in FIG. 3, moving the piston the pressurized position. In one non-limiting embodiment the diaphragm 22 deflects as discussed above when pressure in the chamber 20 is at least thirty pounds per square inch (30 psi) greater than pressure in the exhaust port 30.

If desired, in the non-limiting implementation shown the spring 26 fits into the piston 24, which in turn may define an annular holder 31 around which the lower portion of the spring 26 is disposed as shown to radially support the spring 26. Also if desired, the cover 28 may include a central alignment dome 28a around which the upper portion of the spring 26 is disposed.

In accordance with present principles, a permanent magnet 32 having a north pole “N” and a south pole “S” can be integrated with the piston 24 as by, e.g., press fitting into a side of the piston 24. Also, a Hall sensor 34, which may be mounted on a circuit board 36 and disposed in a sealed chamber 38 that adjoins the sensor body 18, is juxtaposed with the magnet 32 as shown.

The Hall sensor 34 defines a field threshold “T”, shown in FIGS. 2 and 3 by a dashed line. The field threshold “T” in the embodiment shown is a line that is perpendicular to the axial midpoint of the Hall sensor 34. By “axial” midpoint is meant the midpoint of the Hall sensor 34 relative to the dimension of reciprocation of the piston 24.

In the depressurized configuration of FIG. 2, the axial midpoint of the magnet 32, including the entire portion of the south pole “S” of the magnet 32, is below the axial midpoint (and, hence, in the embodiment shown the field threshold “T”) of the Hall sensor 34. A small part of the magnet 32, including the north pole, may be above the threshold “T” as shown in the depressurized configuration. It is to be understood that in other implementations the entire magnet may be located below the threshold “T” in the depressurized configuration.

On the other hand, in the pressurized configuration of FIG. 3, the axial midpoint of the magnet 32, including the entire portion of the north pole “N” of the magnet 32, is above the axial midpoint (and, hence, in the embodiment shown the field threshold “T”) of the Hall sensor 34. A small part of the magnet 32, including the south pole, may remain below the threshold “T” as shown in the pressurized configuration. It is to be understood that in other implementations the entire magnet may be located above the threshold “T” in the pressurized configuration. The pressurized and depressurized positions of the piston represent the upper and lower limits of travel of the piston.

Accordingly, it is now to be appreciated that as the pressure in the chamber 20 moves the piston 24 (and, hence, the axial midpoint of the magnet 32) across the sense threshold “T”, the magnetic field at the Hall sensor 34 prominently changes direction, resulting in a pronounced change in the output of the Hall sensor. Thus, the Hall sensor 24 changes output state at the threshold “T”, with the spring 24 being pre-loaded accordingly. With this cooperation of structure, the total axial “throw” of the piston 24 is relatively small, yet it advantageously results in a pronounced Hall sensor output change.

While the particular NON-CONTACT PRESSURE SWITCH ASSEMBLY is herein shown and described in detail, it is to be understood that the subject matter which is encompassed by the present invention is limited only by the claims.

What is claimed is:

1. A pressure switch assembly, comprising:
a sensor body juxtaposable with a fluid chamber;
a piston disposed in the sensor body for reciprocal movement therein;
a deflectable diaphragm interposed between the piston and fluid chamber;
a spring urging the piston against the diaphragm;
at least one magnet coupled to the piston for movement therewith; and
at least one Hall effect sensor defining a field threshold line and outputting a signal that is affected by the position of the magnet in the sensor body, wherein an axial midpoint of the magnet is on a first side of the field threshold line when the piston is urged by the spring to a depressurized position, the axial midpoint of the magnet being on a second side of the field threshold line when pressure in the chamber deflects the diaphragm to move the piston to a pressurized position.

2. The assembly of claim 1, wherein the field threshold line is along the axial midpoint of the Hall effect sensor.

3. The assembly of claim 1, wherein the spring is disposed in the sensor body.

4. The assembly of claim 1, wherein a portion of the magnet is above the field threshold line in the depressurized position and a portion of the magnet is below the field threshold line in the pressurized position.

5. The assembly of claim 1, wherein as pressure in the chamber moves the piston and, hence, the axial midpoint of the magnet across the field threshold line, the magnetic field at the Hall effect sensor prominently changes direction, resulting in a pronounced change in an output of the Hall effect sensor.

6. A method for sensing pressure, comprising moving a piston under fluid pressure to change a magnetic field in which a Hall sensor is disposed, the field changing polarity at a field threshold line of the Hall sensor at a predetermined piston position, a magnet generating the magnetic field and being coupled to the piston such that portions of the magnet remain on both sides of the field threshold line throughout an entire range of travel of the piston.

7. The method of claim 6, wherein the piston is movable in a sensor body juxtaposable with a fluid chamber, and a deflectable diaphragm is interposed between the piston and fluid chamber.

8. The method of claim 7, wherein a spring urges the piston against the diaphragm.

9. The method of claim 8, wherein an axial midpoint of the magnet is on a first side of the field threshold line when the piston is urged by the spring to a depressurized position, the axial midpoint of the magnet being on a second side of the field threshold line when pressure in the chamber deflects the diaphragm to move the piston to a pressurized position.

10. The method of claim 9, wherein the field threshold line is along the axial midpoint of the Hall effect sensor.

11. The method of claim 9, wherein as pressure in the chamber moves the piston and, hence, the axial midpoint of the magnet across the field threshold line, the magnetic field at the Hall effect sensor prominently changes direction, resulting in a pronounced change in an output of the Hall effect sensor.

12. A non-contact pressure switch assembly for sensing pressure in a vehicle, comprising:
at least one sensor body;
at least one Hall sensor associated with the sensor body; and
at least one piston with integrated magnet reciprocatingly disposed in the sensor body, the piston with magnet being moved under fluid pressure to change a magnetic field in which the Hall sensor is disposed, wherein the field changes polarity at the Hall sensor at a predetermined piston position, the magnet at all times straddling the Hall sensor in the dimension define by piston movement.

13. The assembly of claim 12, comprising:
a deflectable diaphragm interposed between the piston and a fluid chamber; and
a spring urging the piston against the diaphragm, wherein the Hall sensor defines a field threshold line and outputs a signal that is affected by the position of the magnet in the sensor body, wherein an axial midpoint of the magnet is on a first side of the field threshold line when the piston is urged by the spring to a depressurized position, the axial midpoint of the magnet being on a second side of the field threshold line when pressure in the chamber deflects the diaphragm to move the piston to a pressurized position.

14. The assembly of claim 13, wherein the field threshold line is along the axial midpoint of the Hall effect sensor.

15. The assembly of claim 14, wherein as pressure in the chamber moves the piston and, hence, the axial midpoint of the magnet across the field threshold line, the magnetic field at the Hall effect sensor prominently changes direction, resulting in a pronounced change in an output of the Hall effect sensor.
